(19) United States
(12) Patent Application Publication
(10) Pub. No.: US 2015/0223052 A1
(43) Pub. Date: Aug. 6, 2015

(54) Secondary Cell Activation

(71) Applicant: Nokia Solutions and Networks Oy, Espoo (FI)

(72) Inventors: Claudio Rosa, Randers (DK); Klaus Ingemann Pedersen, Aalborg (DK)

(21) Appl. No.: 14/424,614

(22) PCT Filed: Oct. 1, 2012
(86) PCT No.: PCT/EP2012/069313

§ 371 Date: Feb. 27, 2015

(51) Int. Cl. H04W 8/22

(52) U.S. Cl. CPC H04W 8/22

(57) ABSTRACT

A technique including: detecting at a communication device via a primary cell an identification of a plurality of cells operated at respective sites on the same radio resources as potential secondary cells for the communication device; subsequently detecting at the communication device via the primary cell an indication to perform one or more operations for one of the plurality of cells; and in response to the indication, automatically determining not to also perform the one or more operations for all other cells of the plurality of cells; wherein the one or more operations relate to the use of the one cell as a secondary cell for the communication device.

Carrier aggregation (CA) is a technique designed to achieve wider bandwidth transmissions between an access network and a communication device.

A carrier aggregation technique can involve a communication device making or receiving data transmissions via a combination of a primary cell and a secondary cell operated at different frequency bandwidths, such as e.g. different 20 MHz bandwidths. The primary cell is the cell via which the RRC connection is established. A secondary cell operates on a separate e.g. 20 MHz bandwidth, and is configured after an RRC connection is established via the primary cell. The primary cell is activated for the whole period of the RRC connection, but configured secondary cells can be activated or deactivated according to the demand for data transmissions between the access network and the communication device. Activation of a configured secondary cell for downlink transmissions to a communication device involves performing one or more operations at the communication device such as, CQI/PMI/RI/PTI reporting for that secondary cell, PDCCH monitoring on that secondary cell, and PDCCH monitoring on the primary cell for that secondary cell; and activation of a configured secondary cell for uplink transmissions involves making SRS transmissions from the communication device on that secondary cell.

One conventional technique involves providing the communication device with configuration information for a plurality of potential secondary cells, and then explicitly indicating to the communication device for each of the plurality of configured secondary cells whether the respective configured secondary cell is to be activated or deactivated.

The secondary cell can be a cell that is operated at a different transmission point to the primary cell.

The inventors for the present application have identified the challenge of better facilitating secondary cell transmission in an environment where a relatively large number of cells might usefully serve as secondary cells within the coverage area of a primary cell.

There is hereby provided a method, comprising: detecting at a communication device via a primary cell an identification of a plurality of cells operated at respective sites on the same radio resources as potential secondary cells for said communication device; subsequently detecting at said communication device via said primary cell an indication to perform one or more operations for one of said plurality of cells; and in response to said indication, automatically determining not to also perform said one or more operations for all other cells of said plurality of cells; wherein said one or more operations relate to the use of said one cell as a secondary cell for said communication device.

According to one embodiment, said indication comprises a control element specifying a cell index for said one of said plurality of cells.

According to one embodiment, said control element includes a 7-bit or 8-bit field for specifying said cell index.

According to one embodiment, said control element is part of a protocol data unit comprising a sub-header including a field that indicates that said control element specifies a cell index for one cell.

There is also hereby provided a method, comprising: identifying to a communication device via a primary cell a plurality of cells as potential secondary cells for said communication device, wherein said plurality of cells are operated at respective sites on the same radio resources; and subsequently transmitting to said communication device via said primary cell a control element specifying a cell index identifying one of said plurality of cells as a cell for which to selectively perform at said communication device one or more operations related to the use of said cell as a secondary cell.

According to one embodiment, said control element includes a 7-bit or 8-bit field for specifying said cell index.

According to one embodiment, said control element is part of a protocol data unit comprising a sub-header including a field that indicates that said control element specifies a cell index for one cell.

There is also hereby provided an apparatus comprising: a processor and memory including computer program code, wherein the memory and computer program code are configured to, with the processor, cause the apparatus to: detect at a communication device via a primary cell an identification of a plurality of cells operated at respective sites on the same radio resources as potential secondary cells for said communication device; subsequently detecting at said communication device via said primary cell an indication to perform one or more operations for one of said plurality of cells; and in response to said indication, automatically determine not to also perform said one or more operations for all other cells of said plurality of cells; wherein said one or more operations relate to the use of said one cell as a secondary cell for said communication device.

According to one embodiment, said indication comprises a control element specifying a cell index for said one of said plurality of cells.

According to one embodiment, said control element includes a 7-bit or 8-bit field for specifying said cell index.

According to one embodiment, said control element is part of a protocol data unit comprising a sub-header including a field that indicates that said control element specifies a cell index for one cell.

There is also hereby provided an apparatus comprising: a processor and memory including computer program code, wherein the memory and computer program code are configured to, with the processor, cause the apparatus to: identify to a communication device via a primary cell a plurality of cells as potential secondary cells for said communication device, wherein said plurality of cells are operated at respective sites on the same radio resources; and subsequently transmit to said communication device via said primary cell a control element specifying a cell index identifying one of said plurality of cells as a cell for which to selectively perform at said communication device one or more operations related to the use of said cell as a secondary cell.

According to one embodiment, said control element includes a 7-bit or 8-bit field for specifying said cell index.

According to one embodiment, said control element is part of a protocol data unit comprising a sub-header including a field that indicates that said control element specifies a cell index for one cell.

There is also hereby provided a computer program product comprising program code means which when loaded into a computer controls the computer to: detect at a communication device via a primary cell an identification of a plurality of cells operated at respective sites on the same radio resources as potential secondary cells for said communication device; subsequently detecting at said communication device via said primary cell an indication to perform one or more operations for one of said plurality of cells; and in response to said indication, automatically determine not to also perform said one or more operations for all other cells of said plurality of cells; wherein said one or more operations relate to the use of said one cell as a secondary cell for said communication device.

There is also hereby provided a computer program product comprising program code means which when loaded into a computer controls the computer to: identify to a communication device via a primary cell a plurality of cells as potential secondary cells for said communication device, wherein said plurality of cells are operated at respective sites on the same radio resources; and subsequently transmit to said communication device via said primary cell a control element specifying a cell index identifying one of said plurality of cells as a cell for which to selectively perform at said communication device one or more operations related to the use of said cell as a secondary cell.

Embodiments of the present invention are described in detail hereunder, by way of example only, with reference to the accompanying drawings, in which:

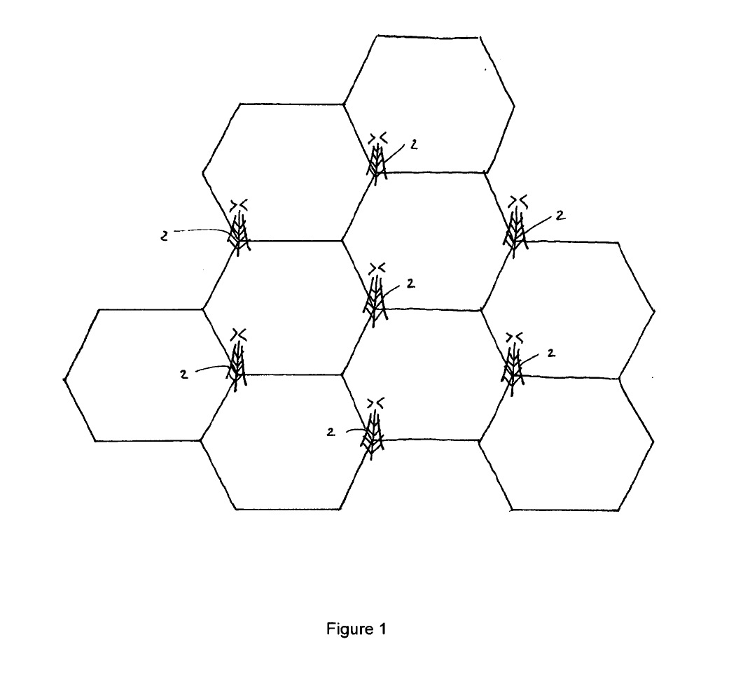

FIG. 1 illustrates an arrangement of macro eNBs to form a cellular network;

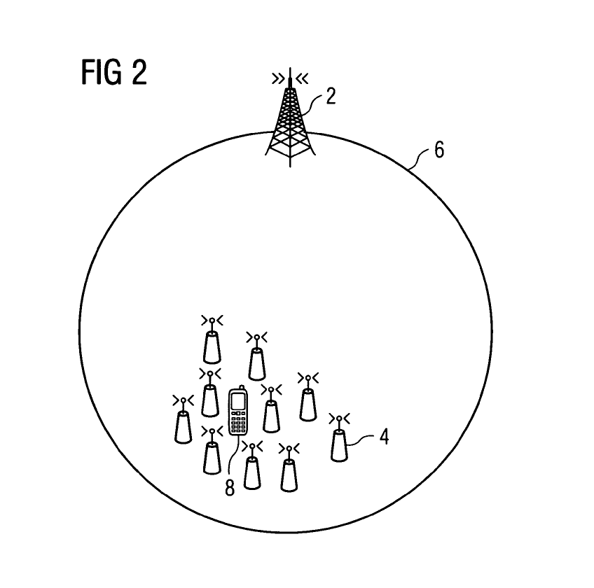

FIG. 2 illustrates one cell of a macro eNB serving a user equipment (UE) whose coverage area is dotted with a relatively large number of non-macro eNBs each operating cells that could function as secondary cells for the UE.

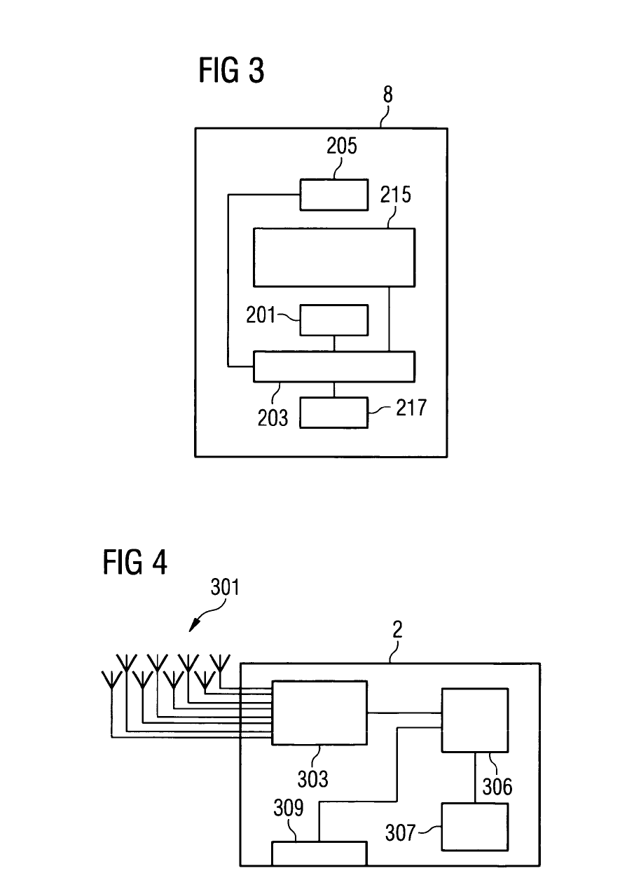

FIG. 3 illustrates an example of apparatus for use at UE in FIG. 2;

FIG. 4 illustrates an example of apparatus for use at the macro and non-macro eNBs in FIG. 2;

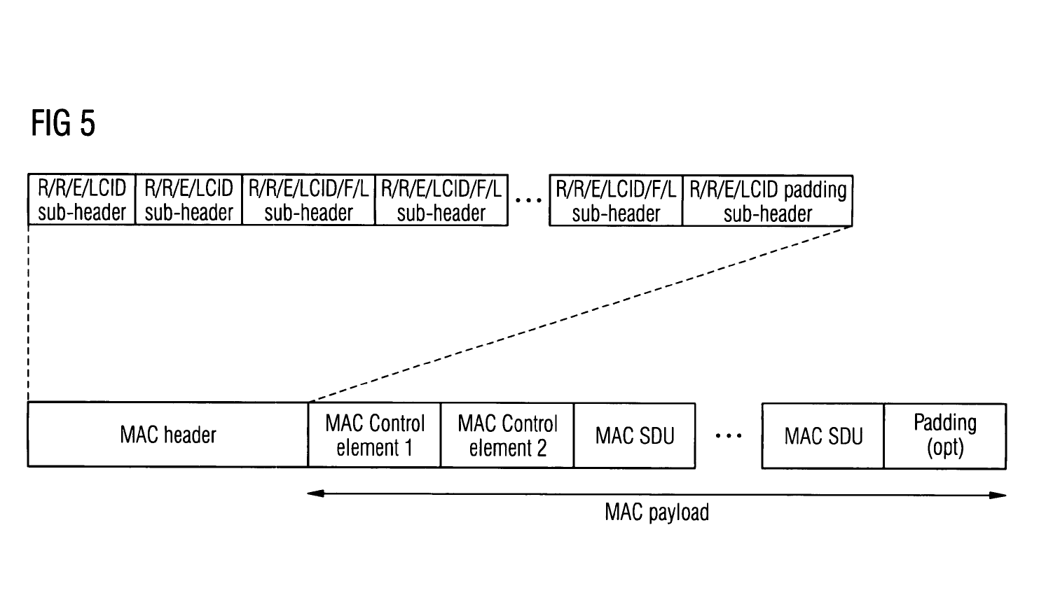

FIG. 5 illustrates the general structure of a medium access control (MAC) protocol data unit;

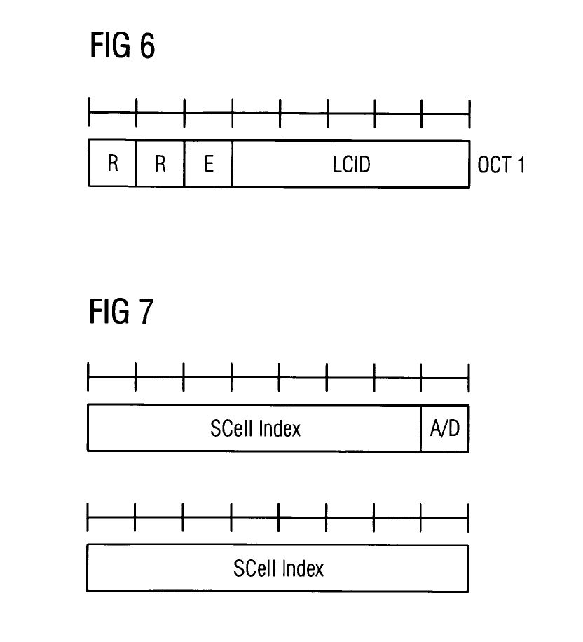

FIG. 6 illustrates an example of the configuration of a sub-header a MAC header;

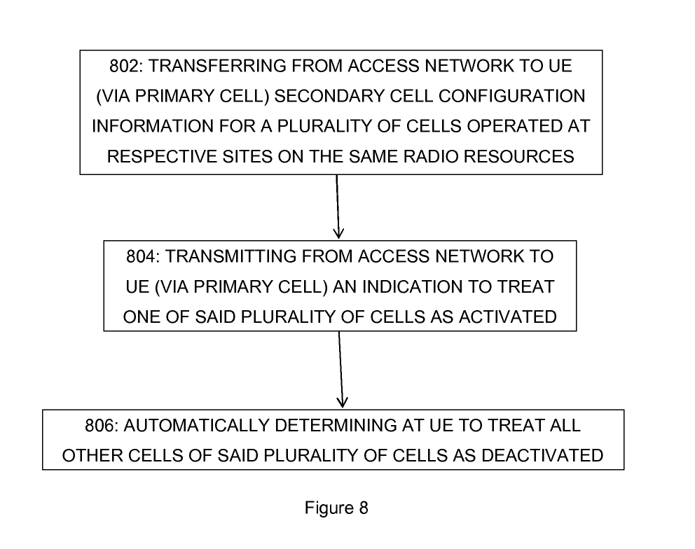

FIG. 7 illustrates examples of MAC control elements for use in a technique according to an embodiment of the present invention; and FIG. 8 illustrates an example of operations at an eNB and UE in accordance with an embodiment of the present invention.

Embodiments of the invention are described in detail below, by way of example only, in the context of a cellular network operating in accordance with an E-UTRAN standard.

FIG. 1 illustrates an example of an array of macro eNodeBs (eNBs) of a cellular network. Only eight macro eNBs are shown in FIG. 1, but a mobile telecommunication network will typically comprise thousands of macro eNBs 2. Each macro eNB 2 typically operates a plurality of cells at different bandwidths. The coverage area of each cell depends on the transmission power and the directionality of the antenna from which the cell is transmitted.

The access network also includes other non-macro eNBs 4 (such as e.g. femto eNBs and pico eNBs) that operate one or more cells whose coverage areas are smaller than the cells of the macro eNBs 2, and which typically overlap with the coverage areas of one or more cells of the macro eNBs 2. FIG. 2 illustrates a user equipment (UE) 2 within the coverage area 6 of a cell of a macro eNB 2 in which are located a number of non-macro eNBs 4.

FIG. 2 only shows a small number of non-macro eNBs 4 within the coverage area of the macro eNB cell, but an access network will typically contain a large number of non-macro eNBs 4. Access networks that combine access nodes with different sizes of coverage area are typically denoted heterogeneous networks (HetNet). Also, FIG. 2 only shows one UE 8, but the combined coverage area of the access network will typically be occupied by a large number of UEs, each served by one of the eNBs. Each of the eNBs 2, 4 is connected by a wired link to a core network (not shown) of the access network.

FIG. 3 shows a schematic view of an example of user equipment 8 that may be used for communicating with the eNBs 2, 4 of FIG. 1 via a wireless interface. The user equipment (UE) 8 may be used for various tasks such as making and receiving phone calls, for receiving and sending data from and to a data network and for experiencing, for example, multimedia or other content.

The UE 8 may be any device capable of at least sending or receiving radio signals to or from the eNBs 2, 4 of FIG. 1. Non-limiting examples include a mobile station (MS), a portable computer provided with a wireless interface card or other wireless interface facility, personal data assistant (PDA) provided with wireless communication capabilities, or any combinations of these or the like. The UE 8 may communicate via an appropriate radio interface arrangement of the UE 8. The interface arrangement may be provided for example by means of a radio part and associated antenna arrangement. The antenna arrangement may be arranged internally or externally to the UE 8, and may include a plurality of antennas capable of operating in the kind of multi-layer transmission scheme described below.

The UE 8 may be provided with at least one data processing entity 203 and at least one memory or data storage entity 217 for use in tasks it is designed to perform. The data processor 213 and memory 217 may be provided on an appropriate circuit board 219 and/or in chipsets.

The user may control the operation of the UE 8 by means of a suitable user interface such as key pad 201, voice commands, touch sensitive screen or pad, combinations thereof or the like. A display 215, a speaker and a microphone may also be provided. Furthermore, the UE 8 may comprise appropriate connectors (either wired or wireless) to other devices and/or for connecting external accessories, for example hands-free equipment, thereto.

FIG. 4 shows an example of apparatus for use at the eNBs 2, 4 of FIG. 1. The apparatus comprises a radio frequency antenna array 301 configured to receive and transmit radio frequency signals; radio frequency interface circuitry 303 configured to interface the radio frequency signals received and transmitted by the 8-antenna array 301 and the data processor 306. The radio frequency interface circuitry 303 may also be known as a transceiver. The apparatus also comprises an interface 309 via which it can send and receive information to and from one or more other network nodes. The data processor 306 is configured to process signals from the radio frequency interface circuitry 303, control the radio frequency interface circuitry 303 to generate suitable RF signals to communicate information to the UE 8 via the wireless communications link, and also to exchange information with other network nodes via the interface 309. The memory 307 is used for storing data, parameters and instructions for use by the data processor 306.

It would be appreciated that the apparatus shown in each of FIGS. 3 and 4 described above may comprise further elements which are not directly involved with the embodiments of the invention described hereafter.

A carrier aggregation technique aimed at increasing the bandwidth for downlink transmissions from the access network to UE 8 can, for example, involve using both (i) one or more cells of a macro eNB 2 and (ii) a cell of a non-macro eNB, for transmissions for a single RRC (Radio Resource Control) connection between the access network and the UE 8.

A technique according to an embodiment of the present invention is described in detail below and with reference to FIG. 8 for the example of UE 8 entering the coverage area of a cell operated by a macro eNB on a e.g. 20 MHz bandwidth carrier forming part of the larger frequency bandwidth F1 assigned to the macro eNB 2. UE 8 establishes a RRC connection with the access network via this cell (primary cell) in accordance with the procedure set out in Section 5.5.3 of 3GPP TS 36.331 V10.6.0. The RRC connection establishment involves establishing the highest-priority signalling radio bearer (SRB1), and is also used to transfer the initial non-access stratum (NAS) dedicated information/message from the UE to the access network.

The coverage area of the macro cell (primary cell) 6 overlaps with the coverage areas of a plurality of cells operated by non-macro eNBs 4 on a common e.g. 20 MHz frequency bandwidth F2 outside of frequency bandwidth F1 assigned to macro eNB 2. After the RRC connection establishment procedure is completed, the access network provides to UE 8 via the primary cell the configuration information needed by UE 8 for downlink (DL) carrier aggregations of (i) the primary cell and (ii) any one of the non-macro eNB cells as a secondary cell (STEP 802 of FIG. 8). This configuration information is provided to UE 8 using the RRC connection reconfiguration procedure described at Section 5.3.5 of 3GPP TS 36.331 V.10.6.0. Non-macro eNB cells for which UE 8 has received the above-mentioned configuration information from the access network are referred to below as configured secondary cells.

Until UE 8 receives an instruction to consider one of the configured secondary cells to be in an activated state, UE 8 configures lower layers (i.e. layers lower than the RRC layer (Layer 3)) to consider the configured secondary cells to all be in a deactivated state.

UE 8 later receives from the access network via the primary cell an instruction to consider one of the configured secondary cells as being in an activated state (STEP 804 of FIG. 8). This instruction takes the form of a MAC control element including 7 or 8 bits for specifying the cell index for the configured secondary cell that is to be considered by the UE as being in an activated state. The MAC control element is part of a MAC protocol data unit having the general structure specified at Section 6.1 of 3GPP TS 36.321 and illustrated in FIG. 5. The UE 8 is configured to automatically consider all other configured secondary cells operating on the same e.g. 20 MHz frequency bandwidth F2 as continuing to be in a deactivated state (i.e. without requiring an explicit indication to this effect from the access network) (STEP 806 of FIG. 8). When UE 8 considers a configured secondary cell to be in an activated state for downlink transmissions to UE 8, UE 8 performs for that configured secondary cell certain predetermined operations that it does not perform for configured secondary cells that are considered to be in a deactivated state. Such predetermined operations include: on that secondary cell; CQI measurement and reporting for that secondary cell (wherein CQI is channel quality indicator); PMI/RI/PTI reporting for that secondary cell (wherein PMI is a precoding matrix indicator, RI is a rank indicator and PTI is a precoding type indicator); PDCCH (physical downlink control channel) monitoring on that secondary cell; and PDCCH monitoring on the primary cell for that secondary cell.

When UE 8 later receives from the access network via the primary cell an instruction to consider a different one of the configured secondary cells as being in an activated state (STEP 804 of FIG. 8), UE 8 is configured to automatically consider all other configured secondary cells operating on the same e.g. 20 MHz frequency bandwidth F2 (including the configured secondary cell that was previously considered by UE 8 to be in an activated state) as being in a deactivated state (i.e. without requiring an explicit indication of this from the access network) (STEP 806 of FIG. 8).

As mentioned above, the above-mentioned MAC control element specifies the cell index of the one of the configured secondary cells to be considered by UE 8 as activated. With reference to the top example of FIG. 7, the above-mentioned MAC control element could also include a 1-bit indication (D/A) of whether the MAC control element is an instruction to consider the secondary cell identified in the MAC control element as activated or deactivated. An explicit instruction to consider a currently activated configured secondary cell as deactivated, could, for example, be used in a situation in which the amount of data transfer from the access network to the UE ceases to warrant the use of any of the non-macro eNB cells as secondary cells. The MAC sub-header associated with the MAC control element includes an LCID (Logical Channel Identifier) that indicates that the MAC control element identifies a single cell (and is not of the conventional bit-map type in which each bit indicates the activation/deactivation state for a respective configured SCell).

According to one variation shown in the bottom part of FIG. 7, all 8-bits of the MAC control element are used for identifying the configured secondary cell that is to be activated or deactivated, and the corresponding sub-header in the MAC protocol data unit (PDU) indicates whether the cell specified in the MAC control element is to be considered as activated or deactivated. As illustrated in FIG. 6, the corresponding sub-header includes a LCID header field, and different LCIDs are used according to whether the cell identified in the corresponding MAC control element is to be considered as activated or considered as deactivated. In FIG. 6, the bits labelled R are reserved bits (set to “0”) and the bit labelled E is an extension field, which is a flag indicating whether or not another set of at least R/R/E/LCID fields are present in the MAC header.

The above-described techniques facilitate the use of any of a relatively large number of non-macro eNB cells as secondary cells for CA transmissions from the access network to UE 8. The access network can efficiently instruct UE 8 to consider as activated any one of up to 128 or 256 (depending on whether 7 or 8 bits are used to identify the activated cell in the above-mentioned MAC control element) cells that may be operating on the same e.g. 20 MHz frequency bandwidth F2 within the coverage area of the primary cell operated by the macro eNB. When UE 8 detects itself to be in the coverage area of one of the non-macro eNB cells for which it has already received configuration information, it informs the access network accordingly via the primary cell, and the access network can efficiently instruct UE 8 to consider that non-macro eNB cell as activated (whereupon the UE 8 automatically considers all other configured Scells operating on the same e.g. 20 MHz frequency bandwidth F2 as being deactivated). In this way, the signalling overhead and delay associated with handovers from the macro layer to the non-macro layer (and vice versa) can be significantly reduced.

Compared to conventional techniques, there may be a relatively large number of configured secondary cells that UE 8 treats as deactivated. Where the standard in accordance with which the UE 8 is required to operate specifies that UE should make some measurements (such as mobility related measurements) even for deactivated cells, large numbers of power-consuming measurements can be avoided by e.g. setting to a large value or even infinity the parameter (e.g. measCycleSCell in TS 36.331) that indicates how often UE should perform the measurements for deactivated secondary cells.

Also, the number of non-macro eNB cells for which UE is provided with configuration information after UE establishes a new RRC connection via a primary cell may be relatively large compared to conventional techniques. One technique for reducing the overhead associated with transferring configuration information to UE 8 is to use one or more messages that specify a common configuration for a plurality of non-macro eNB cells.

In cases where carrier aggregation can also involve a secondary cell (SCell) operated by the macro eNB on a different e.g. 20 MHz carrier within the frequency bandwidth F1 assigned to the macro eNB 2, and e.g. the macro eNB 2 changes both (a) the activation state of a secondary cell operated by the macro eNB (on F1) and (b) the activation state of a secondary cell operated by a non-macro eNB (on F2), the macro eNB 2 would send via the primary cell two activation/deactivation MAC control elements of the kind described above; one for the secondary cell to be activated/deactivated on F1 and one for the secondary cell to be activated/deactivated on F2.

The above-described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The above-described technique is not limited to secondary cells operated at non-macro eNBs. The same technique could be used for secondary cells operated at other macro eNBs at different sites to the macro eNB at which the primary cell is operated.

Also, an embodiment of the technique has been described above for the example of downlink transmissions via primary and secondary cells; but the same kind of the technique can also be used for uplink transmissions via primary and secondary cells.

In addition to the modifications explicitly mentioned above, it will be evident to a person skilled in the art that various other modifications of the described embodiment may be made within the scope of the invention.

1. A method, comprising: detecting at a communication device via a primary cell an identification of a plurality of cells operated at respective sites on the same radio resources as potential secondary cells for said communication device; subsequently detecting at said communication device via said primary cell an indication to perform one or more operations for one of said plurality of cells; and in response to said indication, automatically determining not to also perform said one or more operations for all other cells of said plurality of cells; wherein said one or more operations relate to the use of said one cell as a secondary cell for said communication device.

2. A method according to claim 1, wherein said indication comprises a control element specifying a cell index for said one of said plurality of cells.

3. A method according to claim 1, wherein said control element includes a 7-bit or 8-bit field for specifying said cell index.

4. A method according to claim 2 or claim 3, wherein said control element is part of a protocol data unit comprising a sub-header including a field that indicates that said control element specifies a cell index for one cell.

5. A method, comprising: identifying to a communication device via a primary cell a plurality of cells as potential secondary cells for said communication device, wherein said plurality of cells are operated at respective sites on the same radio resources; and subsequently transmitting to said communication device via said primary cell a control element specifying a cell index identifying one of said plurality of cells as a cell for which to selectively perform at said communication device one or more operations related to the use of said cell as a secondary cell.

6. A method according to claim 5, wherein said control element includes a 7-bit or 8-bit field for specifying said cell index.

7. A method according to claim 6, wherein said control element is part of a protocol data unit comprising a sub-header including a field that indicates that said control element specifies a cell index for one cell.

8. An apparatus comprising: a processor and memory including computer program code, wherein the memory and computer program code are configured to, with the processor, cause the apparatus to: detect at a communication device via a primary cell an identification of a plurality of cells operated at respective sites on the same radio resources as potential secondary cells for said communication device; subsequently detecting at said communication device via said primary cell an indication to perform one or more operations for one of said plurality of cells; and in response to said indication, automatically determine not to also perform said one or more operations for all other cells of said plurality of cells; wherein said one or more operations relate to the use of said one cell as a secondary cell for said communication device.

9. An apparatus according to claim 8, wherein said indication comprises a control element specifying a cell index for said one of said plurality of cells.

10. An apparatus according to claim 8, wherein said control element includes a 7-bit or 8-bit field for specifying said cell index.

11. An apparatus according to claim 9, wherein said control element is part of a protocol data unit comprising a sub-header including a field that indicates that said control element specifies a cell index for one cell.

12. An apparatus comprising: a processor and memory including computer program code, wherein the memory and computer program code are configured to, with the processor, cause the apparatus to: identify to a communication device via a primary cell a plurality of cells as potential secondary cells for said communication device, wherein said plurality of cells are operated at respective sites on the same radio resources; and subsequently transmit to said communication device via said primary cell a control element specifying a cell index identifying one of said plurality of cells as a cell for which to selectively perform at said communication device one or more operations related to the use of said cell as a secondary cell.

13. An apparatus according to claim 12, wherein said control element includes a 7-bit or 8-bit field for specifying said cell index.

14. An apparatus according to claim 12, wherein said control element is part of a protocol data unit comprising a sub-header including a field that indicates that said control element specifies a cell index for one cell.

15. A computer program product comprising program code means which when loaded into a computer controls the computer to: detect at a communication device via a primary cell an identification of a plurality of cells operated at respective sites on the same radio resources as potential secondary cells for said communication device; subsequently detecting at said communication device via said primary cell an indication to perform one or more operations for one of said plurality of cells; and in response to said indication, automatically determine not to also perform said one or more operations for all other cells of said plurality of cells; wherein said one or more operations relate to the use of said one cell as a secondary cell for said communication device.

16. A computer program product comprising program code means which when loaded into a computer controls the computer to: identify to a communication device via a primary cell a plurality of cells as potential secondary cells for said communication device, wherein said plurality of cells are operated at respective sites on the same radio resources; and subsequently transmit to said communication device via said primary cell a control element specifying a cell index identifying one of said plurality of cells as a cell for which to selectively perform at said communication device one or more operations related to the use of said cell as a secondary cell.
